(19) United States
(12) Patent Application Publication
(10) Pub. No.: US 2017/0066020 A1
(43) Pub. Date: Mar. 9, 2017

(54) INDUSTRIAL CLEANLINESS MEASUREMENT METHODOLOGY

(71) Applicant: WALTER SURFACE TECHNOLOGIES INC., Pointe-Claire (CA)

(72) Inventors: Patrick LAPOINTE, Montreal (CA); Nathalie VEZINA, l'Ile Bizard (CA); Myriam GHERIANI, Saint-Laurent (CA); Olga IVANYSENKO, Saint-Laurent (CA); Steven CASSIN, Vaudreuil-Dorion (CA)

(21) Appl. No.: 15/122,017

(22) PCT Filed: Feb. 27, 2015
(86) PCT No.: PCT/CA2015/000130

§ 371 Date: Aug. 26, 2016

Related U.S. Application Data
(60) Provisional application No. 61/945,566, filed on Feb. 27, 2014.

(51) Int. Cl. B08B 3/10; B08B 3/14; G01N 21/91; B08B 15/00; B08B 13/00; G01N 21/94; B08B 3/12; B08B 3/08

(52) U.S. Cl. CPC B08B 3/102; B08B 3/12; B08B 3/14; B08B 3/08; B08B 15/00; B08B 13/00; G01N 21/94; G01N 21/91

(57) ABSTRACT

Systems and methods for performing quantitative detection and analysis of cleanliness and cleanliness levels of components, or pieces of equipment, are disclosed. A cleaning system may have a cleanliness information acquisition module which may acquire, inter alia, optical information about a piece of equipment and a computer-based processing unit may determine a level of cleanliness, an extent to which the piece of equipment is contaminated with a contaminant, and an appropriate cleaning methodology to employ to clean the piece of equipment, using, for example, a cleaning composition which may include a cleaning agent. The cleaning system may execute the cleaning methodology, and once again determine the cleanliness level of the piece of equipment. The cleaning system may also detect the presence or the absence of defects in the piece of equipment. The information collected may also be stored in a database for future reference.

### FIELD

The present disclosure relates generally to the field of industrial cleaning, and more specifically to systems and methods for quantitatively assessing the effectiveness and efficiency of a variety of cleaning methodologies.

### BACKGROUND

Current approaches to industrial cleaning typically focus on observing qualitative changes in cleanliness of a piece of equipment being cleaned, such as whether dirt or grime remains on certain parts of the piece of equipment, how clearly one or more surfaces of the piece of equipment can be seen through the dirt, and the like. Similarly, current approaches to cleaning methodologies are typically limited to cleaning a piece of equipment such that it is “clean enough”, with little regard to the time taken, the amount and type of products used, and the impact on the environment.

Within this context, there is currently no existing standard procedure for determining the effectiveness and efficiency of a cleaning methodology that is easily reproducible, that provides meaningful results and that is unanimously recognized. There is thus a need in the field of industrial cleanliness for a method and a protocol for comparing the cleaning efficiency of different industrial cleaning products on a variety of contaminants.

### SUMMARY

In accordance with a first aspect, the present disclosure relates to a system for measuring cleanliness of a component. The system comprises an optical sensor for receiving optical information conveying an interaction between electromagnetic radiation generated by a source and the component being tested for cleanliness; and a computer-readable medium encoded with non-transitory program code for execution by a data processor, configured to process the optical information to identify zones at a surface of the component that are soiled with a contaminant.

In accordance with another aspect, the present disclosure relates to a method for measuring cleanliness. The method comprises the steps of receiving, with an optical sensor, optical information conveying an interaction between electromagnetic radiation generated by a source and a component tested for cleanliness; processing the optical information with software executed by a data processor to identify zones at a surface of the component that are soiled with a contaminant.

In accordance with another aspect, the present disclosure relates to a system for measuring cleanliness of a component. The system comprises an optical sensor for receiving optical information conveying an interaction between electromagnetic radiation generated by a source and the component being tested for cleanliness; and a computer-readable medium encoded with non-transitory program code for execution by a data processor, configured to process the optical information to distinguish zones at a surface of the component that are soiled with a contaminant from zones at the surface of the component that are free of contaminant.

In accordance with another aspect, the present disclosure relates to a method for cleaning a component having a surface soiled by a contaminant. The method applying a cleaning agent to the surface of the component to clean off the contaminant; receiving with an optical sensor, optical information conveying an interaction between electromagnetic radiation generated by a source and the surface of the component; and processing the optical information with software executed by a data processor to detect the presence of residual contaminant on the surface of the component.

In accordance with another aspect, the present disclosure relates to a system for cleaning a component. The system comprises a cleaning station to clean a component having a surface soiled with a contaminant; an optical sensor for receiving optical information conveying an interaction between electromagnetic radiation generated by a source and the component; and a computer-readable medium encoded with non-transitory program code for execution by a data processor to process the optical information for detecting the presence of contaminant on the surface of the component and to issue control signals to adjust the operation of the cleaning station based on the detecting.

In accordance with another aspect, the present disclosure relates to a method for cleaning a component. The method comprises receiving optical information conveying an interaction between electromagnetic radiation generated by a source and the component; processing the optical information to identify areas of the component that are soiled with a contaminant; and issuing control signals to vary the operation of a cleaning station cleaning the component based on the optical information.

In accordance with another aspect, the present disclosure relates to a cleaning system for cleaning off contaminant from a component using a cleaning agent. The cleaning system comprises an optical sensor for receiving optical information conveying an interaction between electromagnetic radiation generated by a source and the component; and a computer-readable medium encoded with non-transitory program code configured to process the optical information to sense defects in the component based on an interaction between the component and the cleaning agent.

In accordance with another aspect, the present disclosure relates to a method for detecting defects in a component with a cleaning system using a cleaning agent. The method comprises receiving optical information conveying an interaction between electromagnetic radiation generated by a source and the component; processing the optical information to sense defects in the component based on an interaction between the component and the cleaning agent.

In accordance with another aspect, the present disclosure relates to a cleaning agent for cleaning off a contaminant from a surface of a component. The cleaning agent comprises a carrier solution; and a detection agent localizing with defects at the surface of the component to create an optical signature detectable by an optical sensor.

In accordance with another aspect, the present disclosure relates to a cleaning agent for cleaning off a contaminant from a surface of a component. The cleaning agent comprises a carrier solution; and a detection agent interacting with defects at the surface of the component to produce an optical signature detectable by an optical sensor.

In accordance with another aspect, the present disclosure relates to a system for measuring an efficacy of a cleaning agent. The system comprises an optical sensor for receiving optical information conveying an interaction between electromagnetic radiation generated by a source and the cleaning agent; and a computer-readable medium comprising non-transitory program code configured to process the optical information to determine an efficacy of the cleaning agent.

In accordance with another aspect, the present disclosure relates to a method for measuring an efficacy of a cleaning agent. The method comprises receiving optical information conveying an interaction between electromagnetic radiation generated by a source and the cleaning agent with an optical sensor; processing the optical information to determine the efficacy of the cleaning agent.

In accordance with another aspect, the present disclosure relates to a system for documenting cleanliness of a component. The system comprises a database; an optical sensor for receiving optical information conveying an interaction between electromagnetic radiation generated by a source and the component; and a computer-readable medium comprising non-transitory program code for execution by a data processor. The program code is configured to process the optical information to identify areas of the component that are soiled with a contaminant; and store a representation of the cleanliness of the component in the database.

In accordance with another aspect, the present disclosure relates to a method for documenting cleanliness of a component. The method comprises receiving optical information conveying an interaction between electromagnetic radiation generated by a source and a component with an optical sensor; processing the optical information to identify areas of the component that are soiled with a contaminant; and storing a representation of the cleanliness of the component in the database based on the identification of the areas soiled with the contaminant.

In accordance with another aspect, the present disclosure relates to a method for determining the cleanliness of a piece of equipment. The method comprising the steps of determining the cleanliness value of a piece of equipment; submitting the piece of equipment to a cleaning protocol; determining the cleanliness value of the piece of equipment after the cleaning protocol; and comparing the cleanliness value obtained in step the first step with the value obtained in step third to derive a final cleanliness level.

In accordance with various aspects, the present disclosure relates to the use of a detection agent for detecting defects on a surface of a component, wherein the detecting agent localises with the defects at the surface of the component to produce an optical signature detectable by an optical sensor.

In accordance with various aspects, the present disclosure relate to a cleaning agent for cleaning off a contaminant from a surface of a component, comprising: a carrier solution; and a detection agent interacting with defects at the surface of the component, wherein the detection agent produces an optical signature detectable by an optical sensor.

These, and other aspects of the present disclosure, will become apparent to those of ordinary skill in the art upon review of the following description, in conjunction with the accompanying drawings.

### BRIEF DESCRIPTION OF THE DRAWINGS

FIG. 1 is a functional block diagram of a representative embodiment of a cleaning system.

FIG. 2 is a diagram of a representative implementation of a cleanliness information database.

FIG. 3 is a flow chart of a representative method for cleaning a piece of equipment.

FIG. 4A shows a piece of equipment covered in a low-viscosity contaminant.

FIGS. 4B and 4C are mesh plots of cleanliness information relating to the piece of equipment of FIG. 4A.

FIG. 5A shows a piece of equipment covered in a high-viscosity contaminant.

FIGS. 5B and 5C are mesh plots of cleanliness information relating to the piece of equipment of FIG. 5A.

FIG. 6 is a block diagram illustrating application of a cleaning methodology to a contaminated piece of equipment.

FIGS. 7 through 12 illustrate various pieces of equipment at various levels of contamination and/or cleanliness

### DETAILED DESCRIPTION OF EMBODIMENTS

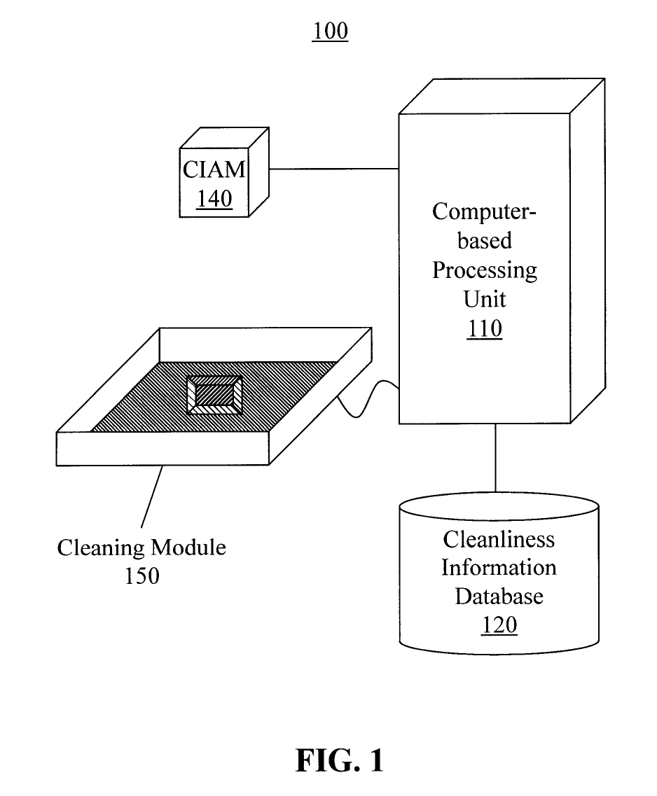

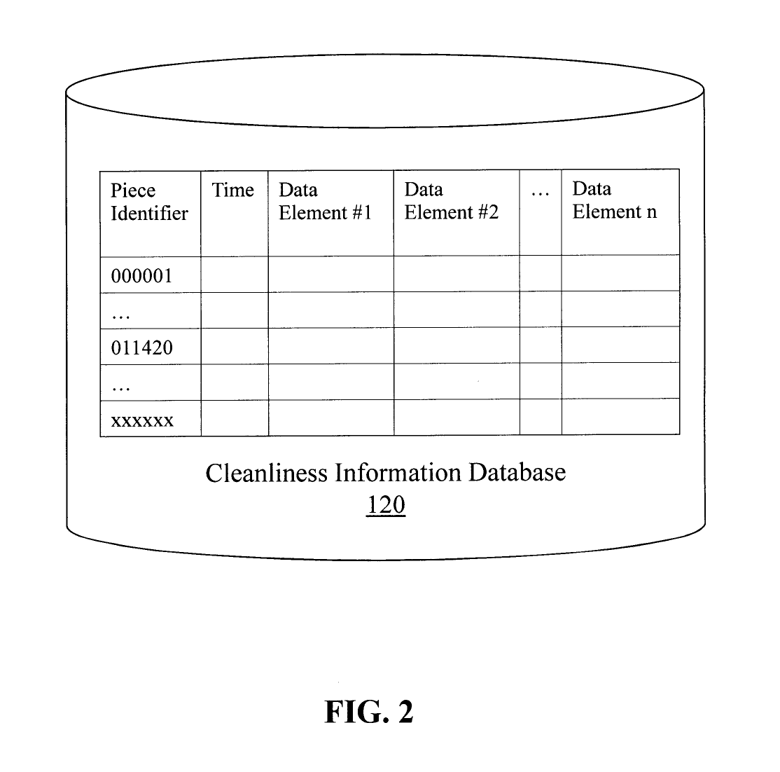

With reference to FIG. 1, in an embodiment, a cleaning system 100 for cleaning pieces of equipment, more generally referred to as components, each having one or more surfaces, is provided. The pieces of equipment may be contaminated, or soiled, with any kind of dirt, grime, impurities, contaminants, and the like, including, for example, oil-based contaminants. The cleaning system 100 generally comprises a computer-based processing unit 110, a cleanliness information database 120, a cleanliness information acquisition module (CIAM) 140 and a cleaning station 150. The computer-based processing unit 110 may be configured to execute (or run) computer code (i.e., software, program code, etc.); in some embodiments, this computer code may be embedded software. Additionally, the CIAM is configured for executing one or more algorithms, either via the computer-based processing unit or independently. Certain embodiments of the cleaning system 100 may clean only one piece of equipment at a time, whereas other embodiments of the cleaning system 100 may be configured to clean multiple pieces of equipment at the same time. Similarly, certain embodiments of the cleaning system 100 may clean only one surface of one or more pieces of equipment at a time, whereas other embodiments of the cleaning system 100 may be configured to clean multiple surfaces of one or more pieces of equipment at the same time. In the following paragraphs, a discussion regarding only a single piece of equipment does not necessarily preclude similar embodiment configured to accommodate a plurality of pieces.

The cleaning system 100 may be distributed in nature, or may be centralized. In a distributed implementation, the computer-based processing unit 110 and the cleanliness information database 120 may be located remotely from the CIAM 140 and the cleaning station 150. In such cases, the CIAM 140 may be configured to communicate with the computer-based processing system 110 and/or the cleanliness information database 120 by way of one or more wired or wireless networks. In an alternate implementation, the cleanliness information database 120 is located remotely from the other components. In some implementations, both the CIAM 140 and the cleaning station 150 are located substantively together and in proximity to the piece of equipment to be cleaned.

In further alternate embodiments, the cleaning station 150 may be a pre-existing cleaning apparatus already in place, for example on a shop floor, in a laboratory, and the like. In such cases, a user of the pre-existing cleaning apparatus may choose to augment the capacities of the pre-existing cleaning apparatus by acquiring and installing, either in close proximity to or directly on the pre-existing cleaning apparatus, at least the CIAM 140. This user may additionally acquire and install the computer-based processing unit 110 and/or the cleanliness information database 120, or they may be accessible over a network, as described above.

With further reference to FIG. 1, the computer-based processing unit 110 can be implemented using a general purpose computer or using specialized circuitry and circuit components, including, but not limited to, a field-programmable gate array (FPGA), an application-specific integrated circuit (ASIC), an embedded system (hardware, software, or mixed), etc. The computer-based processing unit 110 comprises suitable processing means, memory and storage elements, and one or more interfaces for communicating with other elements of the cleaning system 100 (not shown). The computer-based processing unit 110 may also comprise one or more human-computer interfaces (not shown), allowing a user of the cleaning system 100 to interact with the computer-based processing unit 110. This may include one or more display means, audio output means, printers, and any other suitable components (not shown). This may further include one or more input devices, such as keyboards, pointing implements, touch screens, voice-based input means, and any other suitable components (not shown).

With continued reference to FIG. 1, cleanliness information database 120 is communicatively coupled to the computer-based processing unit 110. This coupling may be accomplished by way of a local information link, including cables and short-range wireless communication protocols (Bluetooth®, Wi-Fi, etc.), or may be established over a network, such as the Internet, an intranet, and any other suitable wired or wireless network. In an implementation, the cleanliness information database 120 may be removably coupled to the computer-based processing unit 110, for transport or security purposes. In another embodiment, the cleanliness information database may also be contained within computer-based processing unit 110.

The cleanliness information database 120 is configured to store information (i.e., data) relating to the cleanliness of pieces of equipment which are being cleaned under control of a cleaning methodology by a cleaning system such as the cleaning system 100. In some embodiments, the cleanliness information database 120 may be configured to store a representation of the cleanliness of a piece of equipment. The cleanliness information database may be centralized, or it may be distributed in nature. This information may be stored in a variety of ways, including, but not limited to, textual description, one or more two-dimensional images, one or more three-dimensional models, one or more video files, any suitable combination thereof, or any other storage format. In one implementation of this embodiment, the cleanliness information database stores cleanliness information by way of a series of two-dimensional images. The cleanliness information database may also be configured to store information about the presence or absence of defects in pieces of equipment, and/or a representation of the presence or absence of defects in pieces of equipment.

Information stored in the cleanliness information database 120 may be stored in a variety of ways. In an embodiment, each piece of equipment cleaned by the cleaning system 100 is assigned a sequentially-numbered identifier, and all related cleanliness information, including but not limited to cleaning parameters or assessment information that is collected is stored in the cleanliness information database 120 in association with the sequentially-numbered identifier. In another embodiment, each piece of equipment cleaned by the cleaning system 100 is associated with a pre-assigned identifier, which may be unique, or may be assigned for a period of time and subsequently reused. In this embodiment, all related cleanliness information that is collected is stored in association with the previously-assigned identifier. In a further embodiment, the cleanliness information database is operative for storing cleanliness information in association with one of a sequentially-numbered identifier and a pre-assigned identifier, depending on the piece of equipment being cleaned.

In embodiments where the cleanliness information database 120 stores at least some information in association with a pre-assigned identifier, this identifier may be assigned by the owner of the piece of equipment, by a user of the cleaning system 100, or, in some embodiments, by the cleaning system 100 itself. Pre-assigned identifiers as considered here will be discussed in greater detail in the forthcoming paragraphs.

With reference to FIG. 1, the CIAM 140 generally comprises means for acquiring cleanliness information about a piece of equipment, which may include computing means configured to execute one or more methods or algorithms for acquiring said cleanliness information. The piece of equipment in question may not yet have been cleaned, may be currently undergoing cleaning, or may have already been subjected to one or more cleaning steps. The CIAM 140 comprises one or more sensors, which are discussed hereinbelow.

In one embodiment, the CIAM 140 comprises one or more cameras configured to capture cleanliness information in the form of one or more two-dimensional images of the piece of equipment. The one or more cameras considered may acquire images of the piece of equipment in the visible electromagnetic spectrum, or as viewed within an infrared spectrum, an ultraviolet spectrum, or any combination of electromagnetic spectra which may be conducive to the measurement and/or detection of cleanliness information, and more generally to the operation of the cleaning system 100. The images may be representative of light reflected into the one or more cameras by the piece of equipment, light scattered into the one or more cameras by the piece of equipment, or acquired by any other suitable means. In some embodiments, the one or more cameras may also (or alternatively) be configured to detect an opacity of dirt on the piece of equipment, fluorescence as a result of exposure to certain wavelengths of light; for example, a detection agent (such as a dye or other colouring agent) may be applied to the piece of equipment (this will be discussed in greater detail below) which may fluoresce when exposed to, for example, UV light. In such embodiments, the CIAM 140 may be configured to detect both the interaction of the UV light with the piece of equipment, and the fluorescence/phosphorescence of the colouring agent. In some embodiments, the detection agent may have a higher affinity for zones of the surface of the piece of equipment that are soiled or covered with dirt, and a lower affinity for zones of the surface of the piece of equipment that are not covered with dirt.

The one or more cameras may also be configured to acquire images of a certain polarity, depth of field, and the like. Similarly, the one or more cameras may acquire images in black and white, in greyscale, in any suitable colourspace (RGB, HSB, etc.), and more generally may acquire any suitable type of optical information and/or signals, and at any suitable resolution.

In some embodiments, the CIAM 140 may additionally, or alternatively, comprise one or more light- or sound-based detection means configured to capture cleanliness information relating to a thickness of dirt present on the piece of equipment. This detection means may, for example, be implemented via UV-ray or backscattering-ray system, or may be based on the opacity of the dirt. Other implementations are also possible. In embodiments where the CIAM 140 comprises both one or more cameras and dirt thickness detection means, the CIAM 140 may be configured to generate or construct a three-dimensional model representative of at least part of the dirt present on the piece of equipment.

In an embodiment comprising a plurality of cameras, each of the cameras may work individually or may work together, as part of a camera array. Also, the plurality of cameras may be jointly located or distributed in any useful configuration in order to acquire cleanliness information associated with a piece of equipment. In such an embodiment, the plurality of cameras in the CIAM 140 may acquire cleanliness information in the form of a plurality of two-dimensional images. In an alternate embodiment, the plurality of cameras captures cleanliness information in the form of a three-dimensional model, which may thereafter be processed and displayed on any suitable computing device, including the computer-based processing unit 110.

In another embodiment, the one or more cameras of the CIAM 140 may be mounted to means for displacing the one or more cameras as to allow the one or more cameras to capture cleanliness information from a variety of angles. In such an embodiment, the CIAM 140 may be configured to collect cleanliness information in the form of a series of two-dimensional images, a three-dimensional model, or in the form or one or more video files. In an alternate embodiment, the one or more cameras may be stationary, and the cleaning station 150 (to be described in greater detail in the forthcoming paragraphs) may instead be configured to displace the piece of equipment so as to present the piece of equipment to the cameras at a variety of angles.

Though the preceding paragraphs have considered embodiments of the CIAM 140 comprising one or more cameras, other embodiments are also considered. For example, the CIAM 140 may comprise one or more sound-based imaging systems, such as a SONAR system. Another example CIAM 140 may comprise one or more imaging systems using penetrating and/or back-scattering radiation, such as x-rays, particle-radiation, and the like, and may also be configured to acquire the aforementioned thickness information.

Additionally, some embodiments of the CIAM 140 may comprise a laser-based scanning device. In such embodiments, the CIAM 140 comprises at least one scanning laser, which may be configured to “sweep” an area with a laser beam emitted by the scanning laser, and a detector or other sensor. In some cases, the area which the scanner laser sweeps may be large enough to encompass the whole piece of equipment for which cleanliness information is being acquired. In other cases, the piece of equipment may be placed on a conveyor belt and gradually moved through the area swept by the scanning laser. The detector is then configured to acquire information relating to the interaction of the laser beam emitted by the scanning laser and the piece of equipment. Based on the information so-acquired, the CIAM 140, possibly in conjunction with the computer-based processing unit 110, may be configured to acquire cleanliness information about the piece of equipment, which may be in the form of a two-dimensional image, a three-dimensional model, or any suitable type of information. Moreover, while this discussion refers to a single scanning laser, any number of lasers, emitting laser beams at different (or similar) wavelengths, and any number of detectors, may also be employed.

In short, any embodiment of a CIAM 140 capable of acquiring cleanliness information is also considered.

The CIAM 140 is communicatively coupled to the computer-based processing unit 110. This coupling may be accomplished by way of a local information link, or may be established over a network, such as the Internet, an intranet, and any other suitable wired or wireless network. Additionally, some embodiments of the cleaning system 100 may comprise additional components to aid in the acquisition of cleanliness information, including encoders, decoders, masks, filters, background lighting, etc. Any additional components may be considered as part of the CIAM 140, the computer-based processing unit 110, or more generally, of the cleaning system 100.

With further continued reference to FIG. 1, the cleaning station 150 is configured to implement one or more cleaning methodologies upon a piece of equipment to be cleaned. The cleaning station 150 comprises a basin or a tray in which a piece of equipment may be placed, as illustrated in FIG. 1, but other configurations are also within the scope of the present disclosure.

In embodiments where the cleaning station 150 comprises a basin, it may be configured to comprise a cleaning composition (not shown) as well as a piece of equipment to be cleaned. In these embodiments, the cleaning composition may comprise a carrier solution and/or a cleaning agent. In some implementations, the cleaning composition is in a liquid form or a semi-liquid form. As used herein, the expression “semi-liquid” refers to a composition having the qualities of both of a liquid and a solid.

In such embodiments, the amount of cleaning agent comprised in the cleaning station 150 may vary as a function of the size of the piece of equipment being cleaned, or sought to be cleaned. In embodiments where cleaning system 100 is operative for cleaning more than one piece of equipment at the same time, the amount of cleaning agent may also vary as a function of the number of pieces of equipment being cleaned, or sought to be cleaned.

The basin may also comprise a detection agent instead of, or in addition to, the cleaning agent. In some implementations, the detecting agent is present in the cleaning composition.

The detection agent may be implemented in a variety of ways, such as detectable compounds, dyes, pigments or as any suitable colouring agent, and may be available as an additive to be added to the cleaning agent; alternatively, the cleaning agent may already comprise the detection agent.

In some implementations, the detecting agent may be provided in a concentrated, dried, frozen or lyophilized form. The detection agent and may be added, mixed, diluted and/or solubilized with the components in the basin and/or the components of the cleaning composition including the carrier solution. In some instances, the detection agent may be mixed with the carrier solution and the resulting carrier solution comprising the detecting agent may be added and/or mixed with the cleaning composition.

The detection agent may be configured to interact with the piece of equipment or the dirt present thereon in a variety of ways. In some embodiments, the detection agent may be configured to interact with the dirt present on the piece of equipment to make the dirt more easily detectable by the CIAM 140. This may include dyeing or colouring agents or other chemicals configured to, for example, change the colour, reflectivity, absorptivity, etc., of the dirt present on the piece of equipment, or to cause the piece of equipment, or the dirt thereon, to fluoresce and/or phosphoresce when exposed to certain wavelengths of light. The detection agent may also (or alternatively) be configured to interact with imperfections in the piece of equipment, such as cracks, fissures, holes, depressions, bends, dents, and the like, in such a way as to allow the CIAM 140 to detect such imperfections. For example, the detection agent may include a coloured or brightly coloured or fluorescent or highly fluorescent or phosphorescent or highly phosphorescent compound which may be found and may accumulate in imperfections of the piece of equipment. In some instances, the detection agent may be any molecule that emits detectable radiations upon exposure to light. In some implementations, the detection agent may localize at the sites of imperfections or at the site of dirt to detect these sites.

In some implementations, the detection agent may have a higher affinity for the zones of the surface of the piece of equipment that are contaminated and are to be detected than for the zones of the surface of the piece of equipment that are not contaminated and that should not be detected. Conversely, the detection agent may have a lower affinity for the zones of the surface of the piece of equipment that are contaminated and are to be detected than for the zones of the surface of the piece of equipment that are not contaminated and that should not be detected. In some instances, the detection agent may have a higher affinity for organic matters (such as, for example, but not limited to, grease or greasy or oily substances) than for inorganic matters (such as, for example, but not limited to, metals). In other implementations, the detection agent has a higher affinity for inorganic matters than for organic matters.

In some implementations, the detection agent is a dye. Examples of dyes that may be useful for the methods and the compositions of the present disclosure include, but are not limited to, acid dyes, basic dyes, dyes suitable for direct or substantive dyeing, mordant dyes, vat dyes, reactive dyes, disperse dyes, azoic dyeing, sulfur dyes.

More specific examples of detection agent that may be useful in the methods and compositions of the present disclosure include, but are not limited to, acridine dyes, derivates of acridine, anthraquinone dyes, derivates of anthraquinone; arylmethane dyes, diarylmethane dyes, based on diphenyl methane, triarylmethane dyes, derivates of triphenylmethane, azo dyes, based on —N═N— azo structure, diazonium dyes, based on diazonium salts, nitro dyes, based on a —NO₂ nitro functional group, nitroso dyes, based on a —N═O nitroso functional group, phthalocyanine dyes, derivatives of phthalocyanine, quinone-imine dyes, derivatives of quinone, azin dyes, eurhodin dyes, safranin dyes, derivates of safranin, indamins, indophenol dyes, derivates of indophenol, oxazin dyes, derivates of oxazin, oxazone dyes, derivates of oxazone, thiazine dyes, derivatives of thiazine, thiazole dyes, derivatives of thiazole, xanthene dyes, derived from xanthene, fluorene dyes, derivatives of fluorene, pyronin dyes, fluorone dyes, based on fluorone, and rhodamine dyes, derivatives of rhodamine.

In some other implementations, the detection agent may include a pigment or may be a pigment. Examples of pigments include, but are not limited to, metal-based pigments, cadmium pigments (e.g., cadmium yellow, cadmium red, cadmium green, cadmium orange, cadmium sulfoselenide), chromium pigments (e.g., chrome yellow and chrome green), cobalt pigments (e.g., cobalt violet, cobalt blue, cerulean blue, aureolin (cobalt yellow)), copper pigments (e.g., azurite, Han purple, Han blue, Egyptian blue, Malachite, Paris green, Phthalocyanine Blue BN, Phthalocyanine Green G, verdigris, viridian), iron oxide pigments (e.g., sanguine, caput mortuum, oxide red, red ochre, Venetian red, Prussian blue), lead pigments (lead white, cremnitz white, Naples yellow, red lead), manganese pigments (e.g., manganese violet), mercury pigments (e.g., vermilion), titanium pigments (e.g., titanium yellow, titanium beige, titanium white, titanium black), zinc pigments (e.g., zinc white, zinc ferrite), carbon pigments (e.g., carbon black (including vine blac, lamp black), ivory black (bone char)), clay earth pigments (iron oxides) (e.g., yellow ochre, raw sienna, burnt sienna, raw umber, burnt umber), ultramarine pigments: ultramarine, ultramarine green shade), biological origins (e.g., alizarin (synthesized), alizarin crimson (synthesized), gamboge, cochineal red, rose madder, indigo, Indian yellow, Tyrian purple), non-biological organic (e.g., quinacridone, magenta, phthalo green, phthalo blue, pigment red 170, diarylide yellow).

A person skilled in the art will appreciate that the cleaning agent and the detectable agent

The detection agent may be detectable by the CIAM 140, either when exposed to natural light, or when exposed to certain particular wavelengths of light, and the CIAM 140 may be configured to detect the presence of the detection agent when capturing cleanliness information about the piece of equipment. Information pertaining to these detected imperfections, or the lack thereof, may also be stored in the cleanliness information database 120. In the following paragraphs, the term “cleaning agent” is considered to include those embodiments where the cleaning agent also comprises, or alternatively is composed of, the described detection agent.

In certain embodiments, the cleaning station 150 comprises one or more valves (not shown) through which the cleaning station 150 may be provided with a cleaning agent from an external source (not shown). The one or more valves may also be operative for draining a cleaning agent from the cleaning station 150. In some embodiments, the cleaning station 150 may comprise a filtration system (not shown) configured to recirculate the cleaning agent through a series of one or more reservoirs, tanks, pipes or tubes, filters, pumps, and the like, The cleaning station 150 may thus clean, purify, or otherwise filter impurities from the cleaning agent, for example after having cleaned a piece of equipment.

The cleaning station 150, when comprising a basin, may also comprise a means of vibrating, or otherwise agitating, said basin (not shown). This may be implemented as a fluid stream and/or an ultrasonic bath, for example, or as any other suitable vibration or agitating means. Alternatively, the cleaning station 150 may also comprise a means of sloshing the cleaning agent around within the cleaning station 150, or of creating waves or ripples throughout the cleaning agent (not shown). In these types of embodiments, the cleaning station 150 may also comprise a splash guard or other protective means to prevent the cleaning agent from escaping the cleaning station 150.

The cleaning station 150 may also comprise a heating element (not shown), or conversely, a cooling element (not shown), in order to maintain the cleaning agent at a certain desired temperature, as a reaction between the cleaning agent and dirt elements on a piece of equipment to be cleaned may be exothermic or endothermic in nature. In embodiments where a reaction between a cleaning agent used and dirt elements on a piece of equipment to be cleaned may cause fumes to be released, the cleaning station 150 may also comprise a lid (not shown) or other cover, and may optionally comprise means for evacuating the fumes, such as a fan, pump or other ventilation means.

In other embodiments, the cleaning station 150 may comprise a tray. In such embodiments, the cleaning station 150 serves to support the piece of equipment during a cleaning operation. The cleaning station 150 may also comprise a variety of non-contact cleaning tools, such as soakers, diffusers, water pressure cleaners, air pressure cleaners, laser-based cleaners, torches, flow-through brushes and the like. Other non-contact cleaning tools, including the aforementioned detection agent, are also considered.

The cleaning station 150 may be a stand-alone unit. Any mechanical or electrical appliance which is comprised in the cleaning station 150 may present one or more controls to a user of the cleaning system 100, including, but not limited to, knobs, dials, buttons, switches, and the like (not shown).

Alternatively, the cleaning station 150 may be communicatively coupled to the computer-based processing unit 110. This coupling may be accomplished by way of a local information link, or may be established over a network, such as the Internet, an intranet, and any other suitable wired or wireless network.

In some implementations, cameras are incorporated into or comprised within the cleaning station 150 so as to monitor the piece of equipment during the cleaning procedure. In some examples, the cameras are located within the cleaning agent, or may be otherwise submerged therein.

Other elements may form part of cleaning system 100, and are considered to be within the scope of the disclosure.

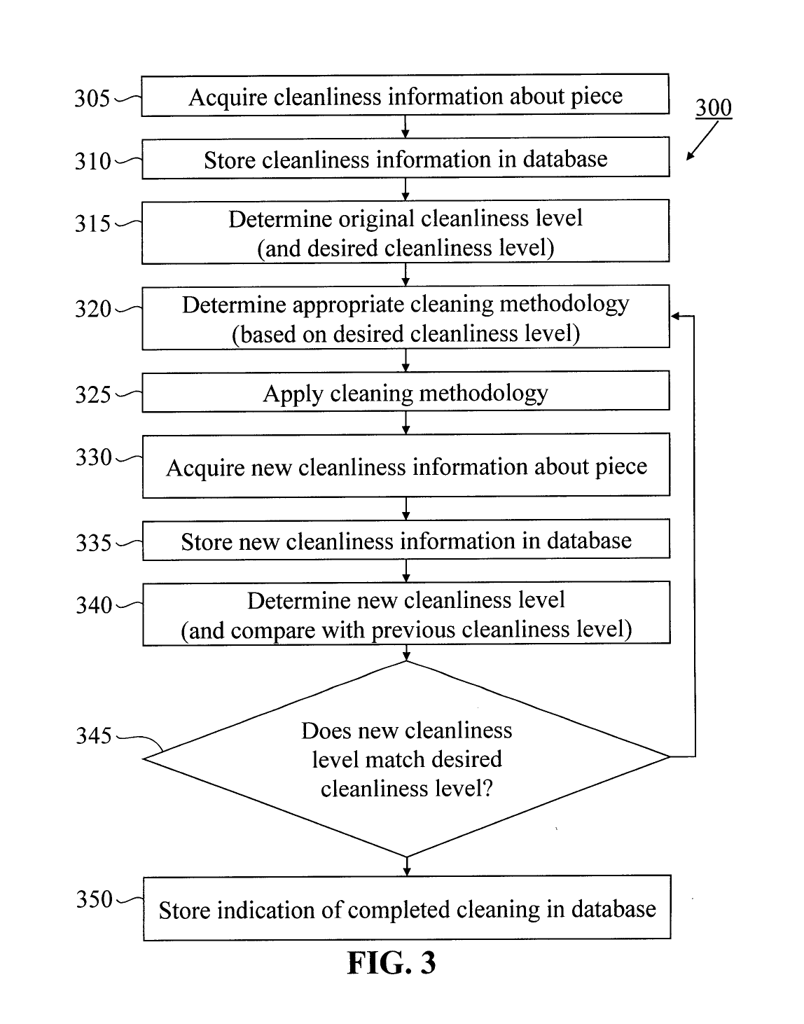

With reference to FIG. 3, the cleaning system 100 is operative for executing a method of cleaning a piece of equipment 300. The cleaning system 100 may also be operative for executing a method of cleaning, at the same time, a plurality of pieces of equipment. While methods of cleaning one or more pieces of equipment may take many forms, an exemplary embodiment of such a cleaning method will now be described.

It is to be understood that herein described steps are described in the context of a representative embodiment. Steps may be performed in a different order than that presented, and certain steps may take place at substantially the same time as other steps, even though they are described herein as occurring in a certain sequential order. Various additional steps, which may be performed at various points throughout the embodiment of the method described herein, are also contemplated.

Step 305

In a representative embodiment, the method begins with acquiring cleanliness information about the piece of equipment to be cleaned. This may be accomplished by the computer-based processing unit 110, the CIAM 140, the cleaning station 150, or any combination of the above-listed components of cleaning system 100.

In some embodiments, the CIAM 140 is in communication with the computer-based processing unit 110, which sends a signal to the CIAM 140, requesting cleanliness information. Upon receipt of the signal, the CIAM 140 may acquire any suitable type of cleanliness information based on the request from the computer-based processing unit 110, or based on pre-determined settings. In other embodiments, the CIAM 140 may be operative to receive user input requesting that the CIAM 140 acquire cleanliness information of a specific type, or of a pre-determined type, which is then passed on to the computer-based processing unit 110.

Alternatively, or in addition, the cleaning station 150 may be in communication with the computer-based processing unit 110, which may send a signal to the cleaning station 150, requesting cleanliness information, which may be supplemental to that acquired from the CIAM 140. Upon receipt of the signal, the cleaning station 150 may acquire any suitable type of cleanliness information based on the request from the computer-based processing unit 110, or based on pre-determined settings. In other embodiments, the cleaning station 150 may be operative to receive user input requesting that the cleaning station 150 acquire cleanliness information of a specific type, or of a pre-determined type, which is then passed on to the computer-based processing unit 110, which may also be supplemental to the cleanliness information acquired from the CIAM 140.

As a part of step 305, the computer-based processing unit 110 may also be operative to acquire identifying information about the piece of equipment to be cleaned. The CIAM 140 and/or the cleaning station 150 may be configured to detect a tracking device located on the piece, or embedded within the piece, such as an RFID tag, two-dimensional bar code, laser etching, or a QR code. The identifying information so acquired may comprise a pre-assigned identifier, as discussed above.

Alternatively, as a part of step 305, the computer-based processing unit 110 may be operative to determine identifying information about a class of a piece of equipment to be cleaned. The CIAM 140 and/or the cleaning station 150 may be configured to detect one or more identifying characteristics of a piece of equipment, such as shape, size, colour, weight, or any other recognizable physical, geometric or chemical characteristic of the piece of equipment to be cleaned. The computer-based processing unit 110 may perform one or more processing steps on the so acquired information to determine the class of the piece of equipment being cleaned. In some embodiments, the computer-based processing unit may be operable to determine, or alternatively assign, an identifier to the piece of equipment to be cleaned based on the determined class. In further alternative embodiments, the computer-based processing unit 110 may be configured to acquire identifying information about the piece of equipment itself, or about its class, by way of user input.

In some embodiments, the process may additionally comprise one or more steps of preparing the piece of equipment to be cleaned, which may take place before, or concurrently with, step 305. Such a step may implement any number of preparation techniques, including the application of one or more chemicals or cleaning agents, use of one or more mechanical cleaning techniques, and the like. In some embodiments, the herein-described method may be executed a first time as a preparation step, and executed a second time as a cleaning step.

Step 310

Once cleanliness information has been acquired by the computer-based processing unit 110, it is stored in the cleanliness information database 120. As discussed previously, the cleanliness information database is configured to store cleanliness information, and if available, in association with an identifier of the piece of equipment to be cleaned.

In embodiments where the computer-based processing unit 110 determines, at step 305, a pre-assigned identifier of the piece of equipment, the cleanliness information database 120 is operative to receive the pre-assigned identifier from the computer-based processing unit, and to store the cleanliness information in association with the pre-assigned identifier. If the computer-based processing unit determines the class of the piece of equipment to be cleaned, based on the aforementioned identifying characteristics, the cleanliness information database 120 may be operative to receive from the computer-based processing unit 110 an identifier of the piece of equipment to be cleaned based on the determined classification of the piece of equipment. If the computer-based processing unit does not provide the cleanliness information database 120 with an identifier, the cleanliness information database 120 may be operative to assign the cleanliness information received from the computer-based processing unit 110 an identifier, such as an identifier from the set of sequentially numbered identifiers discussed above.

Step 315

Once the cleanliness information is stored in the cleanliness information database, the computer-based processing unit may perform various operations on the cleanliness information in order to determine an original level of cleanliness for the piece to be cleaned, including the extent of the contamination of the surface of the piece of equipment.

In embodiments where the cleanliness information comprises one or more two-dimensional images, the computer-based processing unit 110 may apply one or more image processing techniques to determine the original level of cleanliness of the piece of equipment to be cleaned. For example, the cleanliness information may be analyzed to classify each pixel or voxel (in embodiments where thickness information is also acquired) in each of the one or more two-dimensional images as either a “dirty pixel or voxel” or a “clean pixel or voxel”, where a dirty pixel represents a soiled area of the piece of equipment to be cleaned, and a clean pixel represents an unsoiled area of the piece of equipment to be cleaned. Generally speaking, the computer-based processing unit 110 may be configured to distinguish between one or more zones of the surface of the piece of equipment soiled by a contaminant or dirt, and one or more zones of the surface of the piece of equipment free of contaminant or dirt.

Based on the result of this classification, the computer-based processing unit 110 may assign a cleanliness level to the piece of equipment to be cleaned. This cleanliness level may, in some examples, be represented as a percentage (e.g.: 40% dirty, if 40% of the pixels or voxels are dirty pixels or voxels), as a number on a scale (e.g.: level 2 dirty), as a qualitative term (e.g.: somewhat dirty), or using any other suitable quantitative or qualitative system.

More complex image processing techniques may provide further information about the cleanliness level of the piece of equipment to be cleaned, and are considered as being within the scope of the disclosure. For example, the computer-based processing unit 110 may use, amongst others, edge detection algorithms to determine which areas of a piece of equipment are more soiled than others. Imaging techniques using, amongst others, absorption, back-scattering, diffraction pattern or reflectivity detection may also be used, and may provide information about the type of contaminants present on the piece of equipment. Any knowledge obtained from the cleanliness information may be used to alter or effect the determined cleanliness level.

In some alternate embodiments, the computer-based processing unit 110 (and/or the CIAM 140) may, based on an acquired two-dimensional image assign a value, or weight, to each pixel in the image. The scale may be an absolute scale, based on expected values for absolute cleanliness, or may be a relative scale. In some such embodiments, each pixel may be assigned a value between 0 and 255, where a value of 0 represents a very light pixel and a value of 255 represents a very dark pixel. The pixel weightings may then be used to create a mesh plot, where the x-axis and y-axis are representative of the dimensions of the piece of equipment (either in absolute or relative terms), and the z-axis represents the weighting of each of the pixels. This information may then be used to assess which portions of the piece of equipment are dirtier, or more likely to be dirty.

Additionally, the computer-based processing unit 110 and/or the CIAM 140 may be configured to consider other indications of cleanliness, including colour differences, contrast differences, colour/contrast/brightness gradients, and the like. Additionally, if the computer-based processing unit 110 has information indicative of a baseline cleanliness (or background), such as what cleanliness information would be captured by the CIAM 140 for a perfectly clean piece of equipment, the computer-based processing unit 110 may be configured to subtract the baseline cleanliness from the acquired cleanliness information, which may allow the computer-based processing unit 110 to identify which areas of the piece of equipment are less clean. In some other embodiments, the computer-based processing unit 110 may be able to estimate the baseline cleanliness and then perform the same subtraction.

Where other types of cleanliness information are considered, such as three-dimensional models or video files, other relevant processing techniques may be employed to determine a cleanliness level of the piece of equipment to be cleaned.

In certain implementations of this embodiment, the piece of equipment to be cleaned may comprise more than one face or surface, and the original cleanliness level of the piece of equipment to be cleaned maybe determined from the consideration of the original cleanliness level of all of the faces or surfaces of the piece of equipment, or may be determined from the consideration of only some of the faces or surfaces of the piece of equipment.

In certain embodiments, after determining the original cleanliness level, the computer-based processing unit 110 is configured to store the original cleanliness level in the cleanliness information database 120, in association with an identifier of the piece of equipment to be cleaned.

Step 315 also comprises determining a desired cleanliness level. This desired cleanliness level may be a default level (e.g.: 99% clean pixels or voxels), or may be specified based on, for example, the class of a piece of equipment, preceding cleaning history of the piece of equipment, deterioration of the piece of equipment, particular coatings applied to the piece of equipment, surface morphology, etc. In embodiments where the cleanliness of the piece of equipment is based on the aforementioned pixel weighting, the desired cleanliness level may be expressed as an average pixel weighting, or as an absolute pixel weighting, which may include having no pixels above a certain weight, having only a certain percentage of pixels above a certain weight, having a total combined weight being less than a predetermined value, having all pixels within a certain weighting range, etc. In some other implementations, the owner of the piece of equipment to be cleaned may specify a desired level of cleanliness or by a user of the cleaning system 100.

In certain embodiments, the desired cleanliness level may be specified in terms of a cleaning cost specification: for example, the owner of the piece of equipment to be cleaned may indicate that the cost to clean the piece of equipment may be less than a specified amount. The desired cleanliness level may also be specified in terms of a cleaning time specification: for example, a user of the cleaning system 100 may indicate that the time to clean the piece of equipment to be cleaned may take less than a specified amount of time, regardless of the methodology employed. In still further embodiments, the desired cleaning level may be specified in terms of a combination of any of the above factors.

In embodiments where more than one piece of equipment is to be cleaned, where multiple cleaning methodologies are available, or when other factors are present, the computer-based processing system 110 may be operative to inform the owner of the piece(s) of equipment to be cleaned (or alternatively a user of the cleaning system 100) of the cleanliness level of the piece(s) of equipment, of the one or more cleaning methodologies available to effect the cleaning, and any other pertinent information, such as cost estimates, cleaning time estimates, and the like. The computer-based processing unit 110 may then be configured to determine a desired level of cleanliness based on a response received from the owner (or the user).

Step 320

Once the original level of cleanliness and the desired level of cleanliness have been determined, the computer-based processing unit 110 may determine an appropriate cleaning methodology. Various algorithms and techniques may be employed to determine an appropriate cleaning methodology.

In some embodiments, the computer-based processing unit 110 may be configured to receive, via the one or more human-computer interfaces, input from a user of the cleaning system 100 indicating which cleaning methodology may be applied. In other embodiments, the computer-based programming unity 110 may be configured to determine an appropriate cleaning methodology based on the cleanliness information acquired in step 315. According to various aspects, the cleaning methodologies may vary in terms of type of cleaning agent used to clean the piece of equipment, duration of the cleaning procedure, temperature requirement, pH of the cleaning agent, volume of the cleaning agent to be used with respect to the shape and volume of the piece of equipment to be cleaned. In addition, some cleaning methodologies may include one or more techniques for visually enhancing any impurities or dirt which may remain on the piece of equipment after the application of the appropriate cleaning methodology. In such embodiments, the step of determining an appropriate cleaning methodology may also include determining an appropriate technique for visually enhancing the remaining impurities or dirt.

In embodiments where multiple pieces of equipment are cleaned at the same time, the computer-based processing unit 110 may perform steps 305-315 for each piece of the multiple pieces of equipment before determining an appropriate cleaning methodology for the pieces of equipment.

Step 325

The cleaning system 100 then proceeds to apply the cleaning methodology that was determined in step 320. This may include a single cleaning step, or a plurality of cleaning steps. Various cleaning methodologies are also considered.

The selected cleaning methodology may include one or more steps of:
submerging the piece of equipment in a cleaning agent;
subjecting the piece of equipment to ultrasonic vibrations;
applying pressurized water or air to the piece of equipment;
applying a soft laser to the piece of equipment;
diffusion of chemicals and/or markers;
adjusting or varying the pH of the cleaning agent; or
effecting a temperature change in an area proximate to the piece of equipment.

Other cleaning methodologies may also be employed, and are considered to fall within the scope of the present disclosure.

The selected cleaning methodology may be performed automatically by cleaning system 100. Alternatively, once the appropriate cleaning methodology is determined in step 320, the computer-based processing unit 110 may present instructions to the user of the cleaning system 100. The cleaning system may then wait until the user notifies the system that the cleaning methodology has been carried out.

Step 330

In an embodiment, the cleaning system 100 proceeds to acquire new cleanliness information about the piece of equipment by way of the CIAM 140 once the cleaning system 100 has finished applying the cleaning methodology to the piece of equipment. In the case where the cleaning methodology is carried out by a user of the cleaning system 100, the cleaning system 100 may wait on user input before proceeding to this step, as discussed above.

In another embodiment, new cleanliness information may be collected in real-time, or substantially at the same time as step 325 is being effected. In these embodiments, the computer-based processing unit 110 may be configured to issue control signals to vary the operation of the cleaning station 150 In this case, step 325 may continue until the newly collected cleanliness information indicates that a desired level of cleanliness has been achieved. Alternatively, step 325 may continue until the determined cleaning methodology has run its course.

In either case, acquisition of new cleanliness information may be accomplished through techniques similar to those discussed above in relation to step 305. Moreover, the way by which cleaning system 100 acquires new cleanliness information in step 330 does not necessarily have to be the same way cleanliness information was acquired in step 305; for example, as discussed above, an impurity or dirt visualization enhancement methodology may be applied as needed.

In certain embodiments where the cleaning system 100 uses a cleaning agent in order to perform the cleaning methodology, step 330 may also comprise acquiring cleanliness information relating to the cleaning agent used, which may be acquired by the CIAM 140 or by other sensors, such as sensors in the aforementioned filtration system. This may include information about the concentration of the cleaning agent, information about the amount of contaminants present in the cleaning agent, which may be based on one or more of an opacity, a reflectivity, an interference pattern, or a colour of the cleaning agent, or any other kind of relevant cleanliness information. In some embodiments, this may include determining, for example, a number or count of particles in the cleaning agent.

Additionally, the cleaning system 100 may be configured to determine an efficacy of the cleaning agent. This may be estimated, or determined, based on the aforementioned cleanliness level; alternatively, or in addition, the cleaning system 100 may track various metrics regarding the execution of cleaning methodologies, including average time to complete a cleaning methodology, absolute duration of a cleaning methodology, average cleanliness after the execution of a cleaning methodology, number of cleaning methodologies executed since a certain point in time, such as since the last time the cleaning agent was replaced, filtered, or replenished, and the like. Sensors present in the filtration system may also contribute to the determination of the efficacy of the cleaning agent.

Based on this determined efficacy, the cleaning system 100 may be configured to take various steps to improve or correct the efficacy of the cleaning agent. The efficacy of a cleaning agent may be determined periodically, such as after the completion of each cleaning methodology, or may be done in substantially real-time. The computer-based processing unit 110 and/or the one or more sensors of the filtration system may be configured to issue control signals to vary the operation of the filtration system.

For example, if the cleaning system 100 has a range of allowable durations for the execution of a cleaning methodology, and a given execution of this cleaning methodology exceeds this range, the cleaning system may be configured to activate the aforementioned filtration system to cause, for example, the cleaning agent to be filtered. Alternatively, or in addition, the cleaning system 100 may cause one or more tanks and/or reservoirs of the filtration system to provide fresh cleaning agent to the cleaning system 100, where “fresh” denotes cleaning agent that is of a known acceptable efficacy, such as cleaning agent that has yet to be used to execute cleaning methodologies; the providing of fresh cleaning agent may be combined with the removal of cleaning agent with an unacceptable efficacy. In some such embodiments, the filtration system may be configured to completely removed the cleaning agent with unacceptable efficiency, and then provide the fresh cleaning agent to the cleaning system 100. The filtration system may be configured to continue providing fresh cleaning agent and/or continue removing cleaning agent of unacceptable efficacy until an acceptable efficacy is reached.

As another example, a given cleaning agent may be rated for a maximum number of cleaning methodologies before the efficacy of the cleaning agent becomes unacceptable. In such cases, the cleaning system may alert a user of the cleaning system 100 when the maximum number of cleaning methodologies for a given amount of cleaning agent have been executed, and may also suggest that the cleaning agent be filtered, replaced, or the like. Alternatively, or in addition, the cleaning system may, for example, by way of the one or more of the human-computer interfaces of the computer-based processing unit 110, inform a user of the cleaning system 100 of the percent-efficacy of the cleaning agent, and/or of a number of remaining cleaning methodologies which may be executed before the efficacy of the cleaning agent becomes unacceptable.

In certain embodiments where the cleaning system 100 uses a water pressure washer or a compressed air cleaner as a part of cleaning station 150, step 330 may also comprise obtaining pressure information about the elements of cleaning station 150.In these cases, the cleaning system 100 is configured to alert the user of the cleaning system 100 in the event that the cleaning agent or water/air pressure being used is no longer appropriate for the implementation of the cleaning methodology. In embodiments where the cleaning system 100 is configured to capture new cleanliness information in real time, the cleaning system 100 may be configured to alert the user that the cleaning agent or water/air pressure is no longer appropriate at any point throughout method 300.

Additionally, in embodiments where the cleaning agent also comprises a detection agent configured to interact with imperfections in the piece of equipment, the CIAM 140 may be configured to acquire cleanliness information indicative of the presence or absence of such imperfections.

Step 335

Once new cleanliness information has been acquired, the computer-based processing unit 110 may cause the new cleanliness information to be stored in the cleanliness information database 120. As discussed previously in relation to step 310, the new cleanliness information is stored in association with an identifier of the piece of equipment that was cleaned.

Following step 335, the cleanliness information database 120 will comprise cleanliness information about the cleaned piece of equipment acquired both before and after the application of the cleaning methodology. In certain embodiments, the cleanliness information database may also comprise cleanliness information about the cleaned piece acquired at one or more times during the application of the cleaning methodology.

Step 340

At step 340, the computer-based processing unit may employ similar techniques to those discussed in relation to step 315 to determine a new cleanliness level for the piece of equipment being cleaned, including a new extent to which the surface of the piece of equipment is contaminated.

Step 340 may further comprise the computer-based processing unit performing a comparison between the original cleanliness level and the new cleanliness level. The details of how this comparison is carried out will vary with the way the cleanliness level is determined and expressed.

For example, if the cleanliness level is expressed as a percentage of clean pixels or voxels, then the computer-based processing unit may be configured to compare the percentage of clean pixels or voxels in the original cleanliness information with the percentage of clean pixels or voxels in the new cleanliness information. Alternatively, if the cleanliness level is expressed as percentage of dirty pixels voxels, then the computer-based processing unit may be configured to compare the percentage of dirty pixels or voxels in the original cleanliness information with the percentage of dirty pixels or voxels in the new cleanliness information. In embodiments where the cleanliness of the piece of equipment is based on the aforementioned pixel weighting, the comparison may be based on an average pixel weighting, or as an absolute pixel weighting, which may include having no pixels above a certain weight, having only a certain percentage of pixels above a certain weight, having a total combined weight being less than a predetermined value, having all pixels within a certain weighting range, and the like. Cleanliness levels expressed on a numerical scale, or as a qualitative term, may be compared in various other ways.

In certain embodiments, after determining the new cleanliness level, the computer-based processing unit 110 is configured to store the new cleanliness level in the cleanliness information database 120, in association with the identifier of the cleaned piece of equipment. Moreover, a result of the comparison of the original cleanliness level and the new cleanliness level may also be stored in the cleanliness information database 120, in association with the identifier of the cleaned piece of equipment.

In certain embodiments, method 300 may stop after step 340, once the comparison between the original cleanliness information and the new cleanliness information is completed. In the embodiments where such is the case, the comparison of the original cleanliness information and the new cleanliness information may be presented to the user of the cleaning methodology as is.

In some embodiments, the computer-based processing unit 110 may not be able to determine an initial cleanliness level at step 315, and the cleaning methodology chosen at step 320 may thus be done without regard to an initial level of cleanliness, such as based on a user selection, a predetermined “base” cleaning methodology, or any other suitable basis. In such embodiments, the user of the cleaning system 100 may merely be concerned with an amount of dirt removed (or, put differently, in an improvement in cleanliness level). Thus, the computer-based processing unit 110 may be configured for performing a comparison between the cleanliness information acquired in step 310 and the cleanliness information acquired in step 330.

In such embodiments, the computer-based processing unit 110 may be configured to compare the cleanliness information acquired in step 315 to the cleanliness information acquired in step 330, using any of the previously discussed image-processing techniques. This may include pixel weighting, determination of pixel cleanliness, subtracting one image from the other, and the like.

Step 345

In some other embodiments, the method 300 may proceed to step 345, where the computer-based processing unit determines whether the new cleanliness level matches the desired cleanliness level.

In some embodiments, this may comprise effecting similar steps to those discussed in step 340 regarding the comparison of cleanliness levels. For example, if the new cleanliness level is expressed as a percentage of dirty pixels, the computer-based processing unit 110 may compare the percentage of dirty pixels in the new cleanliness information against the allowable number of dirty pixels as established by the desired cleanliness level. For cleanliness levels expressed on other numerical scales, or as a qualitative term, the determination of whether the new cleanliness level matches the desired cleanliness level may be effected in various other ways.

While the previous paragraphs have discussed the new cleanliness level “matching” the desired cleanliness level, the computer-based processing unit 110 is configured to generally compare the new cleanliness level with the desired cleanliness level and to determine whether or not the requirements of the desired cleanliness level have been fulfilled. In some cases, this may mean determining whether the new cleanliness level is equal to or superior to the desired cleanliness level.

Based on this determination, the computer-based processing unit 110 may make a decision. If the new cleanliness level does not match the desired cleanliness level, the method may return to step 320, where the computer-based processing unit 110 may determine a second appropriate cleaning methodology to be applied to the piece of equipment. If, however, the computer-based processing unit determines that the new cleanliness level does match the desired cleanliness level, the method may proceed to step 350.

Step 350

Once the determination is made that the new cleanliness level matches the desired cleanliness level, the computer-based processing unit 110 may cause an indication of the completed cleaning to be stored in the cleanliness information database 120. In some embodiments, the computer-based processing unit 110 may simply store a flag or other indicator of the completed cleaning. In other embodiments, the indication of the completed cleaning may comprise an indication of a comparison between the desired cleanliness level and the new cleanliness level, or an indication of a difference between the desired cleanliness level and the new cleanliness level, or any other suitable information indicative of a result or of progress of the applied cleaning methodology. Additionally, the cleanliness information database 120 may store any information regarding the presence or absence of imperfections in the piece of equipment, if a suitable detection agent was applied to the piece of equipment.

In some embodiments, a user of the cleaning system 100 may acquire one or more reports from the cleanliness information database 120 regarding the cleanliness level and/or the presence or absence of defects, or representations thereof, of one or more pieces of equipment stored in the cleanliness information database 120 in association with a respective identifier, which may or may not be unique. Such reports may be used by a user of the cleaning system 100 to verify, for example, what particular cleaning methodologies were executed on a given piece of equipment and any parameters (temperature, time, cleaning agent used, etc.) thereof, how contaminated the piece of equipment was prior to the execution of the cleaning methodology, how clean the piece of equipment was thereafter, whether the piece of equipment has one or more defects, and the like.

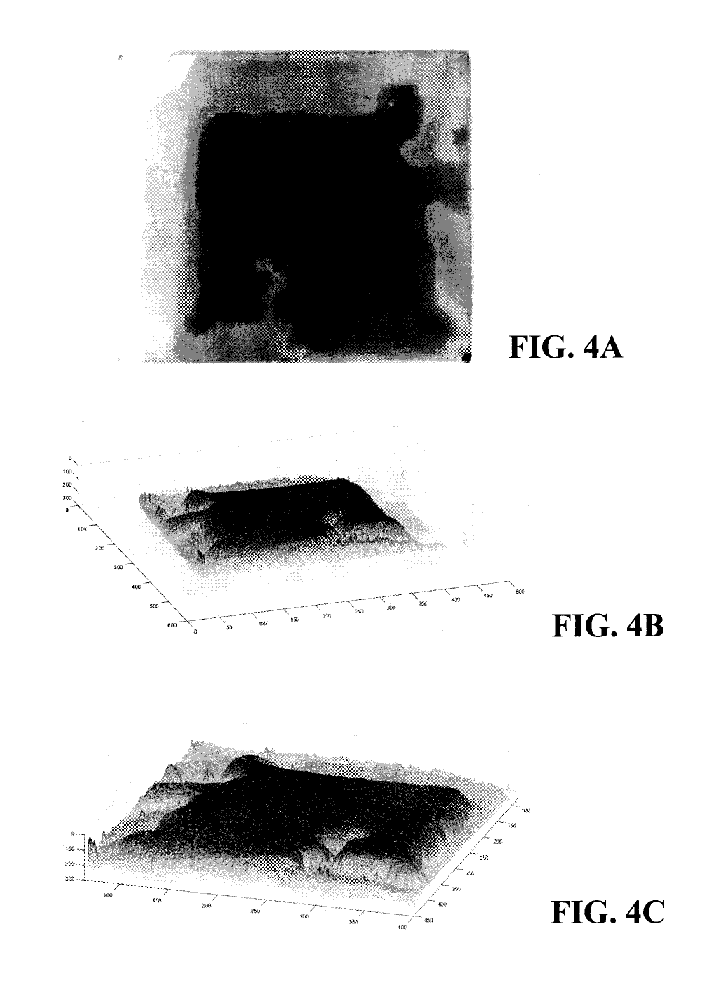

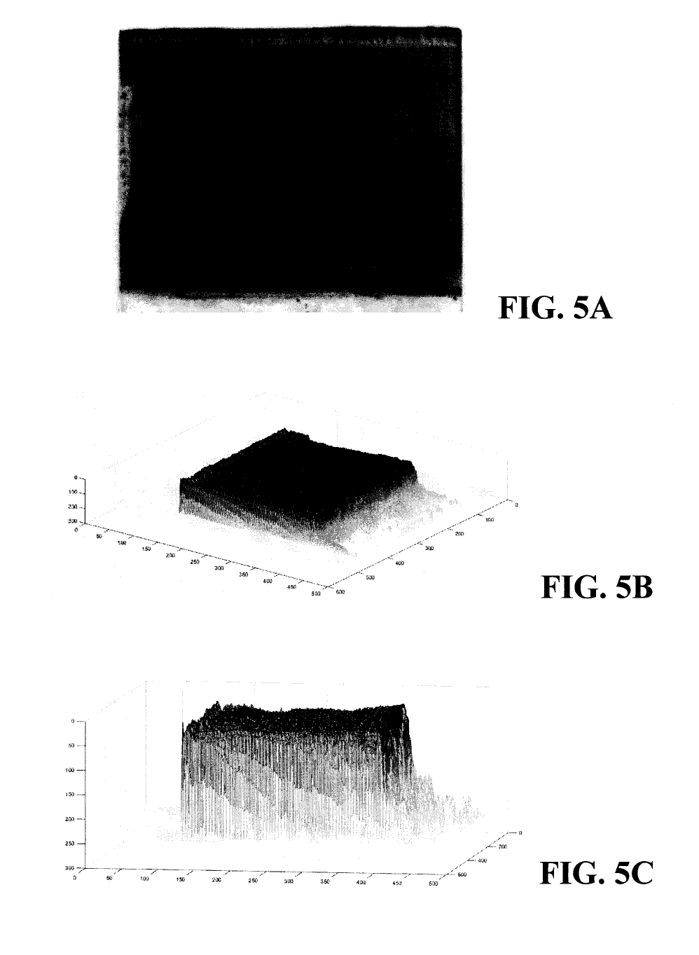

With reference to FIGS. 4A-C and 5A-C, there is shown two example contaminated parts example cleanliness information collected regarding said pieces. More specifically, FIG. 4A shows a piece of equipment covered with a low-viscosity contaminant, and FIG. 5A shows the piece of equipment covered with a high-viscosity contaminant. FIGS. 4B and 5B show collected cleanliness information regarding the low- and high-viscosity-contaminant-covered pieces of equipment, in the form of a mesh plot with the z-axis representing the extent to which each zone of the piece of equipment is contaminating. FIGS. 4C and 5C respectively show the same collected cleanliness information, with the background (i.e., the contribution of the piece of equipment itself) removed.

The present disclosure may also be used to compare the relative effectiveness of different cleaning methodologies, when applied to a common situation. For example, method 300 may be executed on a plurality of substantially identical pieces of equipment, each with a standardized original level of cleanliness. Each of the plurality of substantially identical pieces of equipment may be subjected to a respective cleaning methodology.

In some implementations of these embodiments, the piece of equipment to be cleaned may be selected from a piece of equipment from the field of medical sector, medical device sector, pharmaceutical industry, industrial equipment, aerospace sector, manufacture sector, etc. The surfaces of the piece of equipment to be cleaned may be made of materials such as, but not limited to metal, plastic, glass, ceramic, etc.

In some implementations of the embodiments defined herein, the cleaning protocol may involve the use of cleaner types such as but not limited to water-based (alkaline) cleaning agents, water-based (acidic) cleaning agents, solvent-based (petroleum based) cleaning agents, solvent-based (vegetal extract based) cleaning agents, or any combinations thereof.

### EXAMPLES

### Example 1

Cleaning system 100 is used to easily estimate and compare the cleaning efficiency of industrial cleaners and degreasers.

When comparing solvents, it is common to relate to a scaleless value called the Kauri-butanol value, or “Kb”. Kb is an international, standardized measure of solvent power for a hydrocarbon solvent. The higher this value is, the more powerful the solvent (for a giving type of contaminants).

For water based cleaners, such a value does not exist. In order to compare two cleaners or to evaluate a cleaner efficiency, lab cleaning tests have to be conducted. Literature shows that all cleaning test methods are based on gravimetric measurements (weight difference) or visual assessment (cleanliness level).

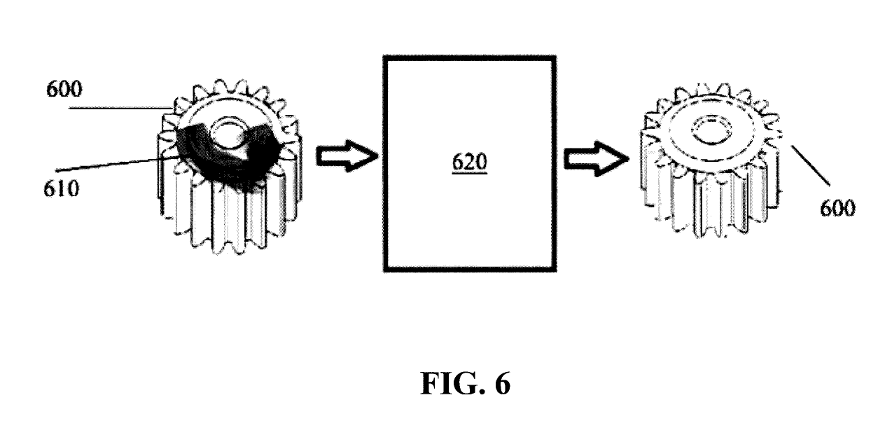

With reference to FIG. 6, existing methods are useful to rapidly compare cleaners and degreasers, but are not capable of providing any numerical values, or a fixed cleaning rating of cleaners and degreasers. In order to find the best method for testing cleaning efficiency, and be able to measure it, different tests have been tried.

For the purposes of comparing and contrasting different cleaning methodologies 620, two general techniques can be selected (though others may also be appropriate):
Soaking (with no mechanical action)+image processing to determine post-cleaning cleanliness level
Soaking+ultrasound bath (mechanical action)+gravimetric measure to determine the amount of contaminant removed.

Using the first general technique, the average cleaning efficiency of each cleaning chemistry may be determined by the quantity of contaminant 610 removed from a component 600 under the same cleaning conditions. The cleaners and degreasers may then be ranked from strongest to mildest based on the amount of contaminant or soil they can remove.

In order to estimate the quantity of the removed contaminant 610 from a piece of equipment 600, a surface enhancement and an image processing method may be used, as described above in relation to step 315. In an embodiment, pictures of contaminated samples may be analyzed before and after the application of a cleaning methodology, and the total cleaned surface may be estimated.

The amount of cleaned surface, or clean pixels, may be proportional to the amount of contaminants 610 removed, and consequently proportional to the cleaning efficiency of the tested cleaner. In some embodiments, step 340 may comprise calculating a numeric ratio of clean pixels to dirty pixels, and may represent a ratio of cleaning performance. This ratio may be determined by image processing techniques, such as pixel counting, as discussed above.

Using the second general technique, the average cleaning efficiency is determined by measuring the total weight of contaminant 610 removed by the cleaner under test. In order to add mechanical action (to mimic one of manual cleaning, pressure washers, ultrasonic cleaners, etc.), an ultrasonic bath may be used.

In such an embodiment, the soiled pieces of equipment 600 are weighed when first clean, after the application of a contaminant 610, such as solid grease, and after the application of a cleaning methodology 620. Various techniques may then be applied to determine the proportion of contaminant removed by the cleaning methodology 620.

### Example 2

Methodology

Two standards have been used to develop the tests procedures:

1—Military Specification: MIL-C-29602 MILITARY SPECIFICATION: CLEANING COMPOUNDS, PARTS WASHER AND SPRAY CABINET (31 Sep. 1999) [S/S BY MIL-PRF-29602A]

2—ASTM D4488-95 Standard Guide for Testing Cleaning Performance of Products Intended for Use on Resilient Flooring and Washable Walls

Both methods are based on using a pre contaminated (soiled) samples and quantifying the amount of soil removed after using the cleaner/degreaser to be tested. The main difference is the procedure used for cleaning. The military specification uses only the solvent/degreasing properties of the cleaner; the ASTM standard includes additional mechanical action (scrubbing/brushing/wiping).

It is important to compare both results, since different cleaners are intended for different applications with or without mechanical action: e.g. a manual parts washing station versus dipping tank or an automatic parts washer. So it is very important, to choose the suitable method depending on the cleaner intended use.

Screening of Potential Methods

When comparing solvents, we usually relate to a scaleless value called Kb. Kb or Kauri-butanol value (“Kb value”) is an international, standardized measure of solvent power for a hydrocarbon solvent. The higher this value is, the more powerful the solvent (for a giving type of contaminants).

For water based cleaners, such a value doesn't exist. In order to compare two cleaners or to evaluate a cleaner efficiency, lab cleaning tests have to be conducted.

With continued reference to FIG. 6, literature shows that all cleaning test methods are based on gravimetric measurements (weight difference) or visual assessment (cleanliness level).

The methods we are currently using are subjective and based on a visual qualitative assessment of the cleanliness level.

45 degree drip test: the liquids to be tested/compared are let to slowly drip on a pre-contaminated surface (inclined at 45 Degrees). The clean track left by the cleaner on the contaminated surface is used to compare 2 cleaners.

Spray and Watch test: we spray the cleaner on the part to be cleaned and see the effect after a certain period of time.

These methods are useful to rapidly compare cleaners and degreasers, but are not capable of providing any numerical values, or a fixed cleaning rating of cleaners and degreasers.

In order to find, the best method for testing cleaning efficiency, and be able to measure it, different tests have been tried.

The following table briefly summarizes these cleaning test methods that are easy to perform in the lab with their feasibility, advantages and disadvantages:

| Method brief | | | | |
|---|---|---|---|---|
| description | Type | contaminant | Advantage | Disadvantage |
| 45 Degre drip test | Visual | Open Gear | Easy and fast | Not reproducible |
| | no | Solid grease | Good to | Not quantifiable |
| | mechanical | | compare 2 | |
| | action | | product at once | |
| Soaking 1: | Visual | Open Gear | Good for | Reproducible |
| A pre-contaminated | magnetic | | comparing | Not suitable for |
| Metal plate is | stirring | | cleaners and | cleaners using |
| immersed in the | | | degreasers | mechanical action |
| cleaner, for a fixed | | | | Not quantifiable |
| period of time | | | | |
| Soaking 2: | Qualitative | Open Gear | fair estimate of | Not suitable for |
| Same as soaking 1+ | (image | | the cleanliness | cleaners using |
| pictures of the final | processing) | | good method | mechanical action |
| results and image | magnetic | | for comparison | |
| processing of the | stirring | | and rating | |
| pictures to | | | | |
| determine | | | | |
| cleanliness level | | | | |
| Soaking 3: | Quantitative | Open Gear | quantification | need for a precision |
| Same as soaking 1+ | gravimetric | | | scale, because the |
| measure of the | method | | | amounts of removed |
| weight difference to | Regular scale | | | soil are very small |
| determine the | magnetic | | | since we are not |
| amount of removed | stirring | | | using mechanical |
| soil | | | | action |
| Soaking 4: | Quantitative: | Open Gear | quantification | Not convenient: |
| Same as soaking 1+ | gravimetric, | | | precision balances |
| using small glass | precision scale | | | are very sensitive |
| blades (used for | magnetic | | | and need to stay very |
| microscopy) instead | stirring | | | clean. These tests are |
| of metal plates + | | | | very messy, since we |
| using a precision | | | | are using greases and |
| scale | | | | liquids. |
| | | | | Very small |
| | | | | quantities of soil |
| | | | | have to be used in |
| | | | | order to be able to |
| | | | | see the difference, |
| | | | | which doesn't |
| | | | | represent the real |
| | | | | work conditions |
| Soaking 5: | Quantitative | Open Gear | quantification | the stirring action is |
| Same as soaking 1+ | gravimetric | | | not sufficient to |
| using bigger metal | method | | | remove enough |
| parts and more | Regular scale | | | grease from the pre- |
| contaminant. | magnetic | | | contaminated part, |
| | stirring | | | and to be able to |
| | | | | quantify the cleaning |
| | | | | efficiency |
| Soaking + ultrasonic | Quantitative: | OPEN GEAR | quantification | Open Gear is not |
| bath: | gravimetric, | | | easy to manipulate |
| Bigger metal parts | regular scale | | | as it drips from the |
| more contaminant | Mechanical | | | samples and sticks |
| | action: | | | everywhere |
| | sonication | | | |
| Soaking + | Quantitative: | Solid grease: | quantification | |
| ultrasound bath: | gravimetric, | (MIL PRF 10924 | reproducible | |
| Bigger metal parts | regular scale | H, Grease | | |
| more contaimant | Mechanical | automotive | | |
| | action: | and artillery) | | |
| | sonication | | | |

Selected Methods:

According to the preliminary tests, here are the methods that may be used:

1—Soaking (no mechanical action)+image processing for cleanliness evaluation

2—Soaking+ultrasound bath (mechanical action)+gravimetric measure to determine the amount of removed soil.

Comparing Cleaning Efficiencies Using the Selected Methods

For detailed description of each method, please refer to appendices.

Soaking and Image Processing Method

The average cleaning efficiency of each cleaning chemistry is determined by the quantity of contaminant/soil removed under the same cleaning conditions. The cleaners and degreasers can then be ranked from strongest to mildest based on the quantity of soil they can remove.

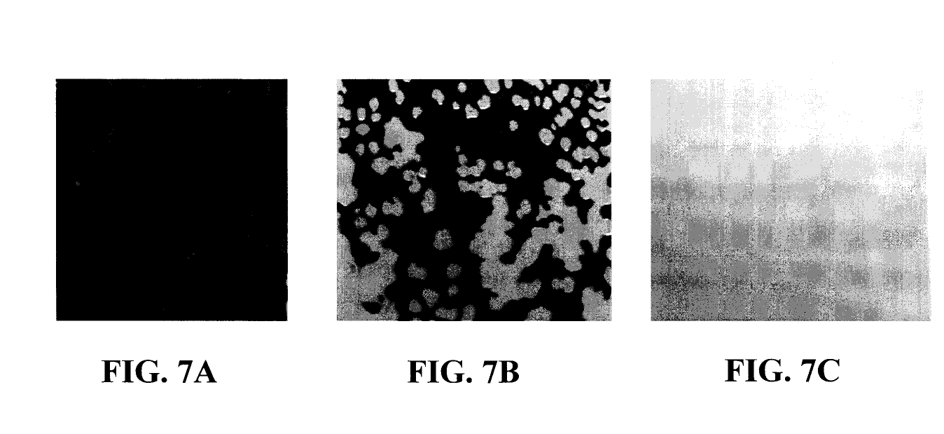

With reference to FIGS. 7A-C, in order to estimate the quantity of the removed soil, we use an image processing method: analyzing pictures of contaminated samples before (FIG. 7A), after a partial cleaning (FIG. 7B), and after a complete cleaning (FIG. 7C), and estimation of the total cleaned surface.

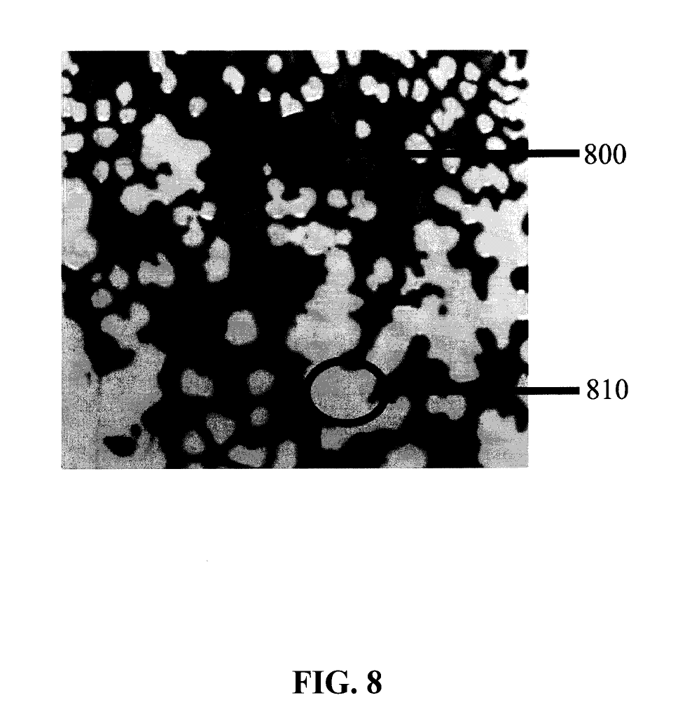

With reference to FIG. 8, the ratio of cleaned surface 810 (lighter colour) is proportional to the amount of removed soil/contaminants 800 (darker colour), and consequently proportional to the cleaning efficiency of the tested cleaner. The numeric ratio of light to dark colour is used as a ratio of cleaning performance. This ratio is determined by image processing techniques: pixel counting for each colour.

$$\% cleaned surface = \frac{\begin{matrix}total number of pixels - \\ number of black and grey pixels\end{matrix}}{total number of pixels} \times 100$$

Results

| Product Name | % cleaned surface | Rank |
|---|---|---|
| CB 100 concentrated | 54.98% | 1 |
| CB 100 50% | 28.12% | 5 |
| CB 100 33% | 10.54% | 8 |
| BT 5 100% | 34.36% | 3 |
| BT 5 50% | 26.04% | 6 |
| BT 5 33% (supplier working concentration) | 20.3% | 7 |
| Bio Circle L-Heated at 40 C. | 2.44% | 10 |
| Bio Circle L + CB 100 10%-Heated at 40 C. | 48.16% | 2 |
| Bio Circle ULTRA heated at 40 C. | 32.2% | 4 |
| SW 4 heated at 40 C. | 9.86% | 9 |

Temperature is ambient temperature unless indicated otherwise

All dilutions are made in water

Ultrasonic Bath and Gravimetric Method

The average cleaning efficiency is determined by measuring the total weight of soil removed by the cleaner to be tested. In order to add mechanical action (to mimic: manual cleaning, pressure washers, ultrasonic cleaners . . . ) we use an ultrasonic bath.

The samples are weighted, when clean (m1), after applying the contaminant (solid grease) (m2) and after cleaning and drying (m3) The quantity of removed soil is determined as follow:

% removed soil=(m2−m3)/(m2−m1)*100

Each test is repeated 3 times.

Results

| Product Name | % removed | soil rating |
|---|---|---|
| CB 100 concentrated | 82.25% | 1 |
| CB 100 at 50% | 69.75% | 3 |
| CB 100 at 33% | 58.61% | 5 |
| BT 5 concentrated | 71.77% | 2 |
| BT 5 at 50% | 54.71% | 6 |
| BT 5 at 33% | 23% | 10 |
| Bio Circle L at 40 C. | 44% | 8 |
| Bio Circle L + 10% CB 100 (at 40 C.) | 67.70% | 4 |
| Bio Circle ULTRA at 40 C. | 52.69% | 7 |
| SW 4 at 40 C. | 32.6% | 9 |

Temperature is ambient temperature unless indicated otherwise

All dilutions are made in water

### CONCLUSIONS

1—when using the same conditions and the same type of contaminants the 2 selected methods are very good to visualize and estimate the cleaning efficiency of water based cleaners and degreasers.

2—In order to use with solvents, these methods may be adapted.

3—When comparing manual parts washer cleaners, the method with mechanical action is preferred.

4—These methods can be used against different types of contaminants, to determine all the contaminants that can be cleaned by a selected product.

5—These methods can be used to determine cleaning efficiency for different dilution rates and at different temperatures.

6—Products comparison: CB 100 is the most efficient cleaner with or without mechanical action; it is probably due to its hybrid nature: water based+natural solvent.

7—Please refer to ratings, for cleaner's comparison.

8—Each test results may be considered and interpreted separately.

In these tests, we are comparing the cleaning efficiency of the main products of Bio-Circle environmental solutions line of cleaners and degreases, and two important products of the competition: BT 5 and SW 4 from Chemfree.

Test Equipment:

Procedure Description

1—Preparation of the samples: 3.5″*2.5″ aluminum plates are cleaned with acetone and dried.

2—Application of the contaminant About 0.4 g of the same contaminant is applied on the clean plates (high load drive lubricant OPENH GEAR), and then spread on the entire surface.

3—Immersion of the contaminated plates

The contaminated sample is then immersed in the cleaning agent to be tested, at the concentration and temperature. The hotplate stirrer is used to agitate the liquid at the pace of 500 rpm (and heat the liquid when applicable). After 5 minutes of immersion, we take the sample out of the liquid (cleaner degreaser), and we quantify the amount of contaminant that have been removed.

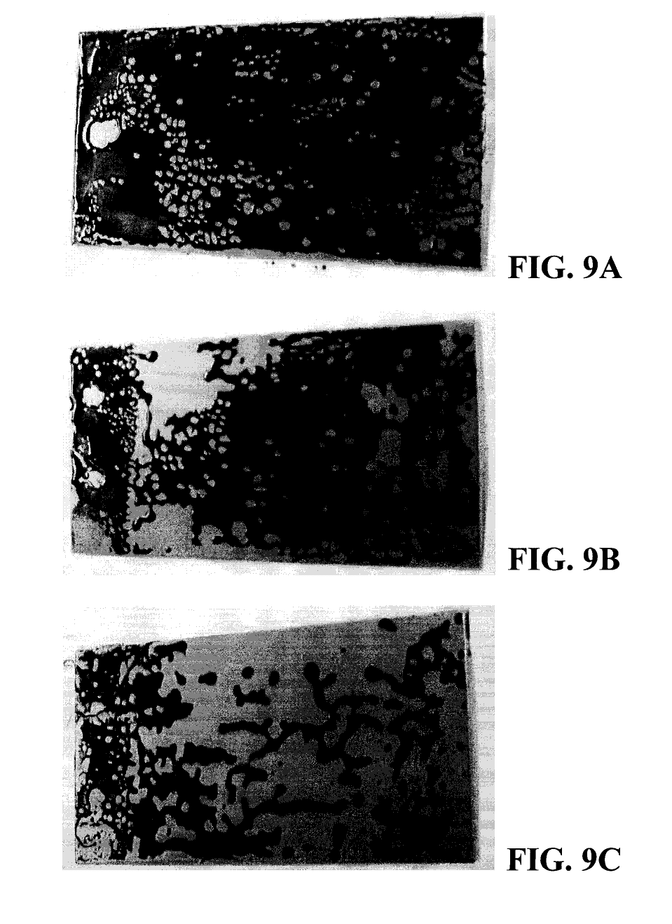

With reference to FIGS. 9A-C, by a simple surface enhanced visual examination, it is possible to compare the cleaning efficiency of the cleaners e.g:

Cleaning tests with CB 100 cleaner and degreaser:

In FIG. 9A, cleaning tests with pure CB 100 degreaser, no dilution (highest rate of cleaning)

In FIG. 9B, cleaning tests with CB 100 degreaser diluted at 33%

In FIG. 9C, cleaning tests with CB 100 degreaser diluted at 50% (lowest rate of cleaning)

Results Interpretation Method

The average cleaning efficiency of each cleaning chemistry is determined by the quantity of contaminant/soil removed under the same cleaning conditions. The cleaners and degreasers can then be ranked from strongest to mildest based on the quantity of soil they can remove.

With continued reference to FIGS. 7A-C, in order to estimate the quantity of the removed soil, we use an image processing method: analyzing pictures of contaminated samples before (FIG. 7A), after a partial cleaning (FIG. 7B), and after a complete cleaning (FIG. 7C), and estimation of the total cleaned surface.

With continued reference to FIG. 8, the ratio of cleaned surface 810 (lighter colour) is proportional to the amount of removed soil/contaminants 800 (darker colour), and consequently proportional to the cleaning efficiency of the tested cleaner. The numeric ratio of light to dark colour is used as a ratio of cleaning performance. This ratio is determined by image processing techniques: pixel counting for each colour.

$$\% cleaned surface = \frac{\begin{matrix}total number of pixels - \\ number of black and grey pixels\end{matrix}}{total number of pixels} \times 100$$

The results are presented according to the nature of the cleaners and degreasers:

Ready to use Water Based Cleaners for manual parts washers

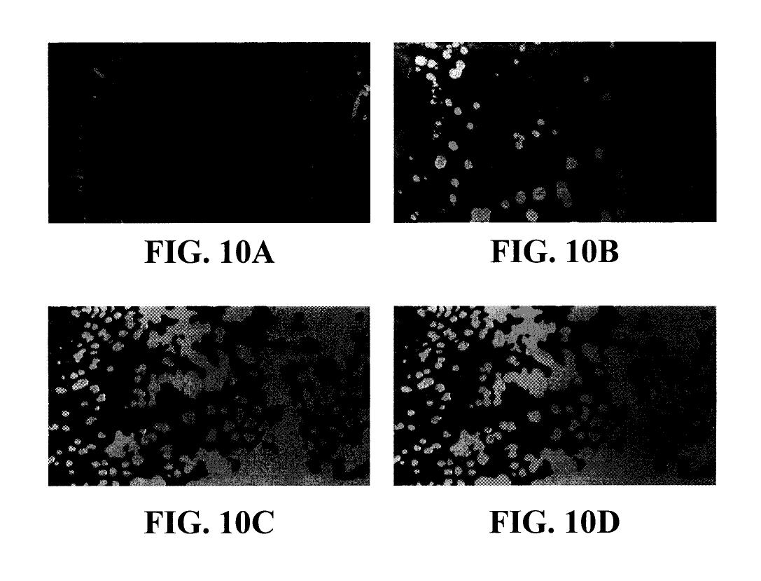

With reference to FIG. 10A, Bio-Circle L, heated at 40C; cleaned surface: 2,44%

With reference to FIG. 10B, W 4, heated at 40C; cleaned surface: 9.86%

With reference to FIG. 10C, Bio-Circle ULTRA, heated at 40C; cleaned surface: 32.2%

With reference to FIG. 10D, Bio-Circle L, heated at 40C, addition of 10% CB 100; cleaned surface: 48.16%

Multipurpose Water based Cleaners (for medium to small potable/bench parts washer stations)

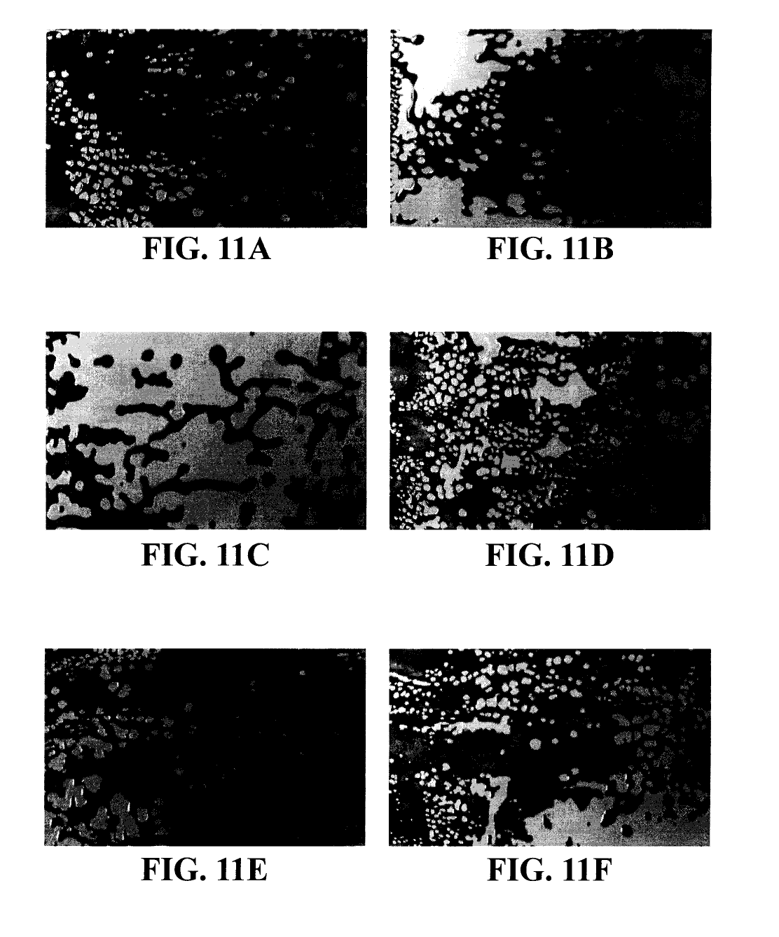

With reference to FIG. 11A, CB 100 33%, room temperature; cleaned surface: 10.53%

With reference to FIG. 11B, CB 100 50%, room temperature; cleaned surface: 28.12%

With reference to FIG. 11C, CB 100 100% (concentrated), room temperature; cleaned surface: 54.98%

With reference to FIG. 11D, BT 5 33%, room temperature; cleaned surface: 20.3%

With reference to FIG. 11E, BT 5 50%, room temperature; cleaned surface: 26.04%

With reference to FIG. 11F, BT 5100% (concentrated), room temperature; cleaned surface: 34.36%

Solvent Based Cleaners and Degreasers

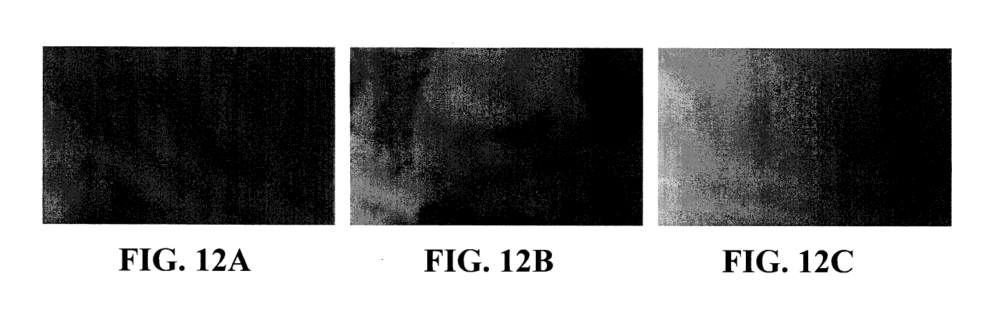

With reference to FIG. 12A, SLAP SHOT; cleaned surface: 100%

With reference to FIG. 12B, SC 400; cleaned surface: 100%

With reference to FIG. 12C, GS 200; cleaned surface: 100%

Comparison Chart for All Tested Products

| | | | | % |
|---|---|---|---|---|
| | | | | cleaned |
| Product Name | Chemistry | Applications | Rank | surface |
| Bio Circle L-Heated | Water | Bio Circle Parts | 11 | 2.44% |
| at 40 C. | based | washing systems | | |
| Bio Circle L + CB 100- | Water | Bio Circle Parts | 5 | 48.16% |
| Heated at 40 C. | Based | washing systems | | |
| Bio Circle ULTRA | Water | Bio Circle Parts | 9 | 32.2% |
| heated at 40 C. | Based | washing systems | | |
| CB 100 100% | Water | Manual cleaning | 4 | 54.98% |
| | Based | and Clean Box | | |
| | | systems | | |
| CB 100 50% | Water | Manual cleaning | 5 | 28.12% |
| | Based | and Clean Box | | |
| | | systems | | |
| CB 100 33% | Water | Manual cleaning | 7 | 10.54% |
| | Based | and Clean Box | | |
| | | systems | | |
| SLAP SHOT | solvent | Manual cleaning | 1 | 100% |
| SC 400 | solvent | Manual cleaning | 2 | 100% |
| | | and cold dipping | | |
| GS 200 | solvent | Manual Cleaning | 3 | 100% |
| | | and dipping | | |
| BT 5 100% | Water | Benchtop parts | 6 | 34.36% |
| | based | washer | | |
| BT 5 50% | Water | Benchtop parts | 7 | 26.04% |
| | based | washer | | |
| BT 5 33% (supplier | Water | Benchtop parts | 8 | 20.3% |
| working concentration) | based | washer | | |
| SW 4 heated at 40 C. | Water | Parts washing | 10 | 9.86% |
| | based | system | | |

All dilutions are prepared with water

Cleaning efficiency mechanical action, using ultrasonic bath and gravimetric measurements

In these tests, we are comparing the cleaning efficiency of the main products of Bio-Circle environmental solutions line of cleaners and degreases, and two important products of the competition: BT 5 and SW 4 from Chemfree.

Test Equipment

Procedure

1—The samples: rectangular metal bars are cleaned with methanol and dried

2—each metal sample is weighed (m1), than a quantity (2 to 3 grams approximately) of grease is applied and spread on the bottom part of the metal samples approximately on same height (about 2 inches). The sample is weighted a second time (m2)

3—Three metal samples (3 repetitions) are immersed in a beaker filled with the water based cleaner to be tested. The beaker(s) are than placed in the ultrasonic bath at a determined temperature (depending on the operating conditions of the cleaner), for 10 mn.

4—After 10 mn of sonication, the samples are removed from the cleaners beakers, rinsed with water to remove any dissolved grease and residual cleaner. The samples are dried for 24 hours (ambient air, room temperature).

5—After drying, each identified sample is re weighted (third measure).

The quantity of removed soil is determined as follow:

% removed soil=(m2−m3)/(m2−m1)*100

We use the results for the 3 samples to determine the average removed quantity for each cleaner and degreaser.

The scope of the claims should not be limited by the preferred embodiments set forth in the examples, but should be given the broadest interpretation consistent with the description as a whole.

1. A system for measuring cleanliness of a component, comprising:
an optical sensor for receiving optical information conveying an interaction between electromagnetic radiation generated by a source and the component being tested for cleanliness; and
a computer-readable medium encoded with non-transitory program code for execution by a data processor, configured to process the optical information to identify zones at a surface of the component that are soiled with a contaminant.

2. The system of claim 1, wherein the program code is further configured to determine a thickness of a layer of the contaminant.

3.-22. (canceled)

23. A method for measuring cleanliness, comprising the steps of:
receiving, with an optical sensor, optical information conveying an interaction between electromagnetic radiation generated by a source and a component tested for cleanliness;
processing the optical information with software executed by a data processor to identify zones at a surface of the component that are soiled with a contaminant.

24.-35. (canceled)

36. The method of claim 23, further comprising applying a detection agent to the surface of the component to make the contaminant detectable by the processing.

37.-39. (canceled)

40. The method of claim 36, wherein the detection agent is a component of a cleaning agent applied to the component to clean off the contaminant.

41. The method of claim 40, wherein the detection agent has a higher affinity for zones of the surface of the component that are soiled with the contaminant than for zones of the surface of the components that are free of the contaminant.

42.-83. (canceled)

84. A system for cleaning a component, comprising:
a cleaning station to clean a component having a surface soiled with a contaminant;
an optical sensor for receiving optical information conveying an interaction between electromagnetic radiation generated by a source and the component; and
a computer-readable medium encoded with non-transitory program code for execution by a data processor to process the optical information for detecting the presence of contaminant on the surface of the component and to issue control signals to adjust the operation of the cleaning station based on the detecting.

85.-140. (canceled)

141. A cleaning system for cleaning off contaminant from a component using a cleaning agent, the cleaning system comprising:
an optical sensor for receiving optical information conveying an interaction between electromagnetic radiation generated by a source and the component; and
a computer-readable medium encoded with non-transitory program code configured to process the optical information to sense defects in the component based on an interaction between the component and the cleaning agent.

142.-268. (canceled)

269. A cleaning agent for cleaning off a contaminant from a surface of a component, comprising:
a carrier solution; and
a detection agent interacting with defects at the surface of the component, wherein the detection agent produces an optical signature detectable by an optical sensor.

270. The cleaning agent of claim 269, wherein the optical signature is representative of the presence or absence of defects at the surface of the component.

271. The cleaning agent of claim 269, wherein the optical signature is representative of the presence or absence of contaminants at the surface of the component.

272. (canceled)

273. (canceled)
